(19) United States
(12) Patent Application Publication
(10) Pub. No.: US 2026/0239001 A1
(43) Pub. Date: Aug. 13, 2026

(54) SYSTEMS AND METHODS FOR PREVENTING SECURITY ATTACKS IN FIFTH GENERATION ROAMING SCENARIOS

(71) Applicant: Verizon Patent and Licensing Inc., Basking Ridge, NJ (US)

(72) Inventors: Violeta Cakulev, Millburn, NJ (US); Hossein M. Ahmadi, Parsippany, NJ (US); Ali Imdad Malik, East Brunswick, NJ (US); Lixia Yan, Basking Ridge, NJ (US)

(21) Appl. No.: 19/052,750

(22) Filed: Feb. 13, 2025

(51) Int. Cl. H04W 12/06; H04W 8/02; H04W 84/04

(52) U.S. Cl. CPC H04W 12/06; H04W 8/02; H04W 84/042

(57) ABSTRACT

A device may include a processor configured to receive a request from a Security Edge Protection Proxy (SEPP) in a Visited Public Land Mobile Network (VPLMN), wherein the request is associated with a User Equipment (UE) device; send an authentication request for the UE device to a subscription management device; and receive an authentication response for the UE device from the subscription management device. The processor may be further configured to perform an authentication of the UE device based on the received authentication response; and respond to the request based on the performed authentication of the UE device.

### BACKGROUND INFORMATION

To satisfy the needs and demands of users of mobile communication devices, providers of wireless communication services continue to improve and expand available services as well as networks used to deliver such services. One aspect of such improvements includes enabling mobile communication devices to access and use various services via the provider's communication network. For example, the provider may need to facilitate communication with other networks. Managing communication with other networks may pose various difficulties.

### BRIEF DESCRIPTION OF THE DRAWINGS

FIG. 1 illustrates an environment according to an implementation described herein;

FIG. 2 illustrates exemplary components of a core network according to an implementation described herein;

FIG. 3 illustrates exemplary components of a device that may be included in network components according to an implementation described herein;

FIG. 4 illustrates exemplary components of a Security Edge Protection Proxy (SEPP) device according to an implementation described herein;

FIG. 5 illustrates exemplary components of a Unified Data Management (UDM) device according to an implementation described herein;

FIG. 6 illustrates a flowchart of a first process for authentication a request from a Visited Public Land Mobile Network (VPLMN) according to an implementation described herein;

FIG. 7 illustrates a flowchart of a second process for authentication a request from a Visited Public Land Mobile Network (VPLMN) according to an implementation described herein;

FIG. 8 illustrates a first exemplary signal flow diagram according to an implementation described herein;

FIG. 9 illustrates a second exemplary signal flow diagram according to an implementation described herein; and

FIG. 10 illustrates a third exemplary signal flow diagram according to an implementation described herein.

### DETAILED DESCRIPTION OF PREFERRED EMBODIMENTS

The following detailed description refers to the accompanying drawings. The same reference numbers in different drawings identify the same or similar elements.

Providers of wireless communication services operate radio access networks (RANs) that include base stations. The base stations enable wireless communication devices (e.g., smart phones, etc.), referred to as user equipment (UE) devices, to connect to networks and obtain services via the provider's core network, such as a Fourth Generation (4G) core network and/or a Fifth Generation (5G) core network. For example, a UE device may connect to a third-party application server via an application installed on the UE device.

As cellular wireless networks and services increase in size, complexity, and number of users, management of the communication networks has become more complex. One way in which wireless networks are becoming more complicated is by incorporating various aspects of next generation networks, such as 5G mobile networks, utilizing high frequency bands (e.g., 24 Gigahertz, 39 GHz, etc.), and/or lower frequency bands such as Sub 6 GHz, and a large number of antennas. 5G New Radio (NR) radio access technology (RAT) provides significant improvements in bandwidth and/or latency over other wireless network technology.

5G networks may include a roaming architecture that enables operators to expand roaming agreements with other providers. A roaming agreement with another provider may enable a UE device to use the other provider's network, referred to as a visited network, when the UE device is outside the coverage area of the home network (e.g., the network to which the user of the UE device is subscribed to receive services, etc.) and in the coverage area of the visited network. Standards developed by the Third Generation Partnership Project (3GPP) for operation of 5G networks have defined a Home Routed (HR) architecture and a Local Breakout (LBO) architecture for roaming.

In HR, all data plane traffic is directed to the subscriber's home network, referred to as the Home Public Land Mobile Network (HPLMN). The HPLMN may thus process and forward the data traffic to its destination. The HR architecture enables the HPLMN to control and monitor data traffic with respect to the subscriber's activity from a visited network, referred to as the Visited Public Land Mobile Network (VPLMN). In contrast, an LBO architecture enables the VPLMN to grant UE devices direct access to external networks through the VPLMN's User Plane Function (UPF), bypassing routing through the HPLMN. Thus, the LBO architecture reduces latency in data traffic, since the data traffic does not have to travel through the HPLMN. However, the LBO architecture reduces reliability from the HPLMN's perspective, as the HPLMN loses visibility into, and control over, the data plane for evaluating and accounting for the subscriber's activity while the subscriber is connected to the VPLMN. Therefore, the HR architecture may be the preferrable roaming architecture adapted by providers for 5G networks.

However, the HR architecture poses security concerns, because the HPLMN needs to communicate with a VPLMN on behalf of UE devices. Therefore, the HPLMN may need to authenticate requests received from the VPLMN on behalf of a UE device. A PLMN interconnection interface in 5G, and/or associated Application Programming Interface (API) to handle messages between LPMNs, is referred to as the N32 interface. The 5G core network entity that may implement the N32 interface and handle firewall functionality between the HPLMN and a VPLMN is the Security Edge Protection Proxy (SEPP). The SEPP may be the preferred point of contact into and out of a Mobile Network Operator's (MNO's) network at the Hypertext Transfer Protocol/2 (HTTP/2) application level of communication. In order to satisfy 5G security requirements, a SEPP may need to perform authentication of requests received from a VPLMN in order to prevent various types of security attacks.

Implementations described herein relate to systems and methods for preventing security attacks in 5G roaming scenarios. An entity in an HPLMN 5G core network may be configured to perform an authentication check on requests from a VPLMN on behalf of a UE device. For example, a device configured to implement a SEPP, and/or a device configured to implement a Unified Data Management (UDM) function, may perform a previous location check that compares a last seen authenticated location with a location associated with a received request, and/or perform a time location check that compares a time and a location between messages. Messages that indicate an unusually rapid change of location, for example, as measured by consecutive authenticated locations from non-bordering countries within a short time period, may be flagged as suspicious and filtered and/or denied access to the HPLMN.

For example, a device, which includes a SEPP in an HPLMN associated with a UE device, may be configured to receive a request from another SEPP in a VPLMN on behalf of the UE device. The request may include, for example, a Protocol Data Unit (PDU) session establishment request, a Policy Association Request, a Registration Request, a request to report telemetry information, and/or another type of request from a VPLMN to an HMPLN, on behalf of the UE device. The device may be configured to send an authentication request for the UE device to a subscription management device, receive an authentication response for the UE device from the subscription management device, perform an authentication of the UE device based on the received authentication response, and respond to the request based on the performed authentication of the UE device.

In some implementations, the subscription management device may include a Unified Data Repository (UDR). Thus, in some implementations, the SEPP may be configured to communicate directly with the UDR in the core network. In other implementations, the subscription management device may include a Unified Data Management (UDM) function. Therefore, in other implementations, the SEPP may communicate with the UDM and the UDM may obtain the authentication information from the UDR.

In some implementations, the authentication request for the UE device may include a request to perform a previous location check for the UE device and/or a request to perform a time location check for the UE device. Thus, in some implementations, a previous location check and/or a time location check for the UE device may be performed by the UDM and the result of the previous location check and/or time location check for the UE device may be provided to the SEPP. In other implementations, the authentication response for the UE device may include information identifying a most recently reported PLMN to which the UE device was connected and a timestamp associated with a report of the most recently reported PLMN to which the UE device was connected. Therefore, in other implementations, when performing the authentication of the UE device based on the received authentication response, the SEPP may be configured to perform a previous location check for the UE device based on the received authentication response and/or perform a time location check for the UE device based on the received authentication response.

Responding to the request based on the determination as to whether to authenticate the UE device may include approving the request, when the previous location check satisfies a previous location requirement and the time location check satisfies a time location requirement. Furthermore, responding to the request based on the determination as to whether to authenticate the UE device may include denying the request, when the previous location check does not satisfy a previous location requirement or when the time location check does not satisfy a time location requirement.

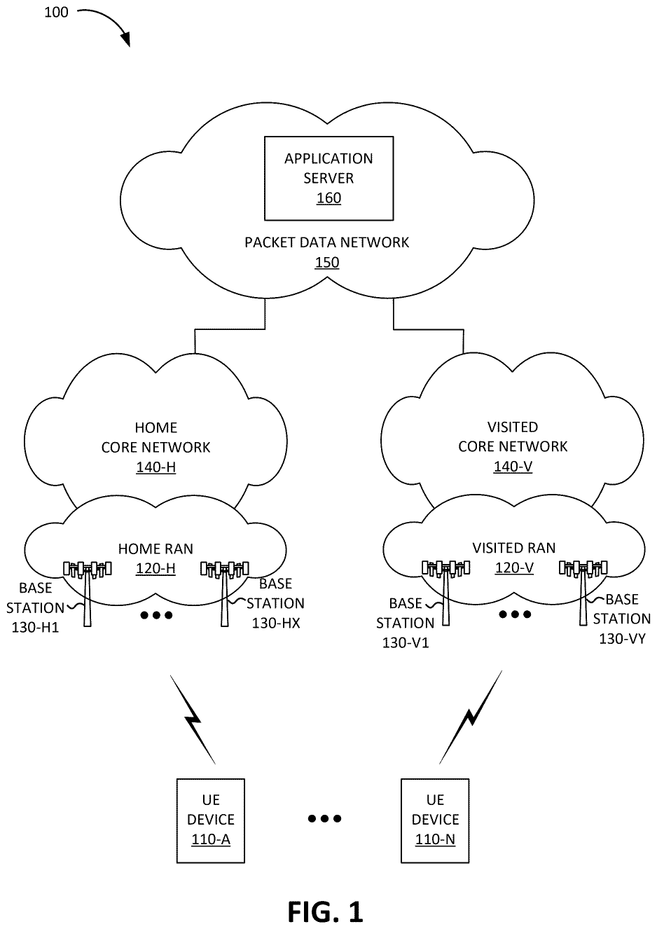

FIG. 1 is a diagram of an exemplary environment 100 in which the systems and/or methods, described herein, may be implemented. As shown in FIG. 1, environment 100 may include UE devices 110-A to 110-N (herein collectively referred to as “UE devices 110” and individually as “UE device 110”), a home RAN 120-H that includes base stations 130-H1 to 130-HX (herein collectively referred to as “base stations 130” and individually as “base station 130”), a home core network 140-H, a visited RAN 120-V that includes base stations 130-V1 to 130-VY, a visited core network 140-V, and a packet data network (PDN) 150 that includes an application server 160.

UE device 110 may include any mobile device with cellular wireless communication functionality. UE device 110 may include a handheld wireless communication device (e.g., a mobile phone, a smart phone, a tablet device, etc.); a wearable computer device (e.g., a head-mounted display computer device, a wristwatch computer device, etc.); a laptop computer, a tablet computer, or another type of portable computer; a WI-FI access point (AP), a portable gaming system; and/or any other type of mobile computer device with cellular wireless communication capabilities. In some implementations, UE device 110 may communicate using machine-to-machine (M2M) communication, such as Machine Type Communication (MTC), and/or another type of M2M communication for Internet-of-Things (IoT) applications. In some implementations, UE device 110 may include an Unmanned Aerial Vehicle (UAV).

Base station 130 may include a 5G New Radio (NR) base station (e.g., a gNodeB) and/or a Fourth Generation (4G) Long Term Evolution (LTE) base station (e.g., an eNodeB). Each base station 130 may include devices and/or components configured to enable cellular wireless communication with UE devices 110. For example, base station 130 may include a radio frequency (RF) transceiver configured to communicate with UE devices using a 5G NR air interface using a 5G NR protocol stack, a 4G LTE air interface using a 4G LTE protocol stack, and/or using another type of cellular air interface.

Home RAN 120-H may include base stations 120 and be managed by a provider of wireless communication services. Home RAN 120-H may enable UE devices 110 to connect to core network 140 via base stations 120 using cellular wireless signals. For example, home RAN 120-H may include one or more central units (CUs), distributed units (DUs), and/or Radio Units (RUs) (not shown in FIG. 1) that enable and manage connections from RUs to home core network 140. Home RAN 120-H may include features associated with an LTE Advanced (LTE-A) network and/or a 5G network or other advanced network, such as management of 5G NR base stations; carrier aggregation; advanced or massive multiple-input and multiple-output (MIMO) configurations (e.g., an 8×8 antenna configuration, a 16×16 antenna configuration, a 256×256 antenna configuration, etc.); cooperative MIMO (CO-MIMO); relay stations; Heterogeneous Networks (HetNets) of overlapping small cells and macrocells; Self-Organizing Network (SON) functionality; MTC functionality, such as 1.4 Megahertz (MHz) wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of LTE-A and/or 5G functionality.

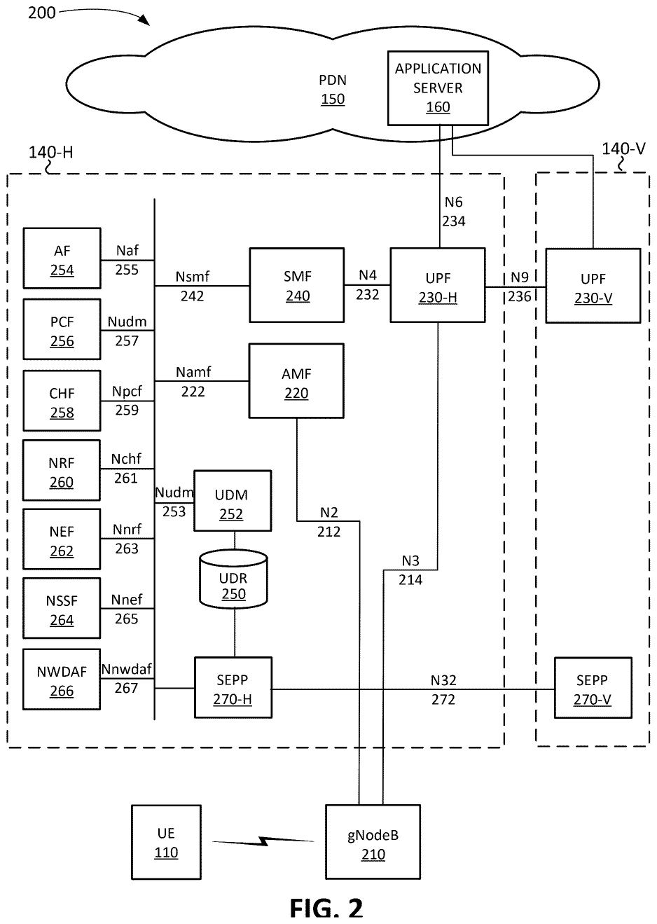

Home core network 140-H may be managed by the provider of cellular wireless communication services and may manage communication sessions of subscribers connecting to home core network 140 via home RAN 120-H. For example, home core network 140-H may establish an Internet Protocol (IP) connection between UE devices 110 and PDN 150. Home core network 140-H may include a 5G core network. Exemplary components of a 5G core network are described below with reference to FIG. 2.

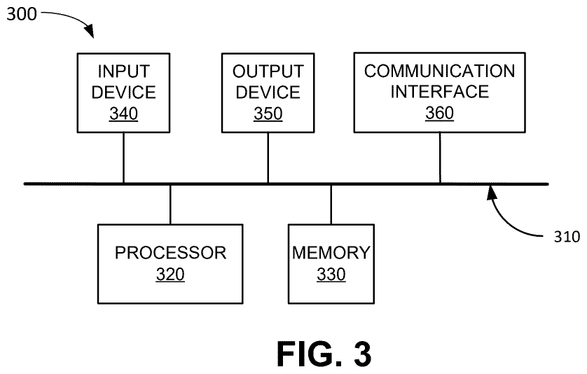

The components of home core network 140-H may be implemented as dedicated hardware components and/or as Virtualized Network Functions (VNFs) implemented on top of a common shared physical infrastructure. For example, a VNF may be implemented using a VNF virtual machine, a Cloud-Native Network Function (CNF) container, an event driven serverless architecture interface, and/or another type of VNF architecture. The common shared physical infrastructure may be implemented using one or more devices 300 described below with reference to FIG. 3 in a cloud computing center associated with home core network 140-H. Additionally, or alternatively, some, or all, of the common shared physical infrastructure may be implemented using one or more devices 300 included in a Multi-Access Edge Computing (MEC) network (not shown in FIG. 1) associated with home RAN 120-H.

Visited RAN 120-V and/or visited core network 140-V may be used by UE device 110 when UE device 110 is out of the coverage area of home RAN 120-H. UE device 110 may attach to, and/or register with, visited core network 140-V via visited RAN 120-V when UE device 110 leaves the coverage area of home RAN 120-H and enters the coverage area for visited RAN 120-V. Visited RAN 120-V may have components and functionality similar to what is described above for home RAN 130-H. Visited core network 140-V may have components and functionality similar to what is described above for home core network 140-H. Visited RAN 120-V and/or visited core network 140-V may be managed by a different provider than the provider managing home RAN 120-H and home core network 140-H; and home core network 140-H may have a PLMN identifier (ID) different from the PLMN ID of visited core network 140-V. Home RAN 120-H may be configured to communicate with visited RAN 120-V to perform handovers of UE device 110. Furthermore, visited core network 140-V may be configured to communicate with home core network 140-H to manage communication services for UE device 110 in an HR architecture for roaming scenarios. For example, visited core network 140-V may send requests to home core network 140-H on behalf of UE device 110 when UE device 110 is connected to visited RAN 120-V and/or visited core network 140-V.

PDN 150 may be associated with an Access Point Name (APN) and/or Data Network Name (DNN) and UE device 110 may request a connection to PDN 150 using the APN or DNN. PDN 150 may include, and/or be connected to and enable communication with, a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks. Application server 160 may include one or more computer devices that host one or more applications used by UE device 110 and/or provides another type of service to UE device 110. For example, UE device 110 may request to connect to application server 160 and, in response, visited core network 140-V may send a PDU session establishment request to home core network 140-H on behalf of UE device 110.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 illustrates an implementation 200 of home core network 140-H as a 5G core network. As shown in FIG. 2, implementation 200 includes UE device 110, gNodeB 210, home core network 140-H, visited core network 140-V, and PDN 150. Home core network 140-H may include an Access and Mobility Function (AMF) 220, a home User Plane Function UPF 230-H, a Session Management Function (SMF) 240, a UDR 250, a UDM 252, an Application Function (AF) 254, a Policy Control Function (PCF) 256, a Charging Function (CHF) 258, a Network Repository Function (NRF) 260, a Network Exposure Function (NEF) 262, a Network Slice Selection Function (NSSF) 264, a Network Data Analytics Function (NWDAF) 266, and a home SEPP (270-H). Visited core network 140-V may include at least a visited UPF 230-V and a visited SEPP 270-V. Other components of visited core network 140-V are not shown in FIG. 2.

While FIG. 2 depicts a single AMF 220, UPF 230, SMF 240, UDR 250, UDM 252, AF 254, PCF 256, CHF 258, NRF 260, NEF 262, NSSF 264, NWDAF 266, and SEPP 270, for illustration purposes, in practice, home core network 140-H may include multiple AMFs 220, UPFs 230, SMFs 240, UDRs 250, UDMs 252, AFs 254, PCFs 256, CHFs 258, NRFs 260, NEFs 262, NSSFs 264, NWDAFs 266, and/or SEPPs 270. gNodeB 210 may be part of home RAN 120-H and may include base station 130. gNodeB 210 may communicate with AMF 220 via N2 interface 212 for control plane messaging and via UPF 230 via N3 interface 214 for data plane traffic.

AMF 220 may perform registration management, connection management, reachability management, mobility management, lawful intercepts, session management messages transport between UE device 110 and SMF 240, access authentication and authorization, location services management, functionality to support non-3GPP access networks, and/or other types of management processes. AMF 220 may be accessible by other function nodes via an Namf interface 222.

UPF 230 (e.g., UPF 230-H in home core network 140-H) may maintain an anchor point for intra/inter-RAT mobility, maintain an external Packet Data Unit (PDU) point of interconnect to a particular PDN 150, perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a RAN node (e.g., gNodeB 210), and/or perform other types of user plane processes. UPF 230 may communicate with SMF 240 using an N4 interface 232 and connect to PDN 150 using an N6 interface 234. UPFs in different HPLMNs may communicate with each other using an N9 interface 236. For example, home UPF 230-H may communicate with visited UPF 230-V via N9 interface 236.

SMF 240 may perform session establishment, session modification, and/or session release, perform IP address allocation and management, perform Dynamic Host Configuration Protocol (DHCP) functions, perform selection and control of UPF 230, configure traffic steering at UPF 230 to guide the traffic to the correct destinations, terminate interfaces toward PCF 256, perform lawful intercepts, charge data collection, support charging interfaces, control and coordinate of charging data collection, terminate session management parts of Non-Access Stratum messages, perform downlink data notification, manage roaming functionality, and/or perform other types of control plane processes for managing user plane data. SMF 240 may be accessible via an Nsmf interface 242.

UDR 250 may store subscription information for UE devices 110. A subscription record for UE device 110 may store authentication information for UE device 110. Additionally, the subscription profile may store information from location updates for UE device 110 indicating a current or last known location for UE device 110 and/or a network to which UE device 110 is connected (e.g., home core network 140-H, visited core network 140-V, etc.). UDM 252 may function as an interface to UDR 250. For example, when UE device 110 attaches to visited core network 140-V, UDM 252 may receive, from a visited AMF 220 in visited core network 145, information identifying visited core network 140-V.

Furthermore, UDM 252 may, via UDR 250, maintain subscription information for UE devices 110, generate authentication credentials, handle user identification, perform access authorization based on subscription data, perform network function registration management, maintain service and/or session continuity by maintaining assignment of SMF 240 for ongoing sessions, support Short Message Service (SMS) message delivery, support lawful intercept functionality, and/or perform other processes associated with managing user data. In some implementations, UDM 252 may be configured to perform a previous location check and/or a time location check for UE device 110 when a request from visited SEPP 270-V is received on behalf of UE device 110. UDM 252 may be accessible via a Nudm interface 253.

AF 254 may provide services associated with a particular application, such as, for example, an application for influencing traffic routing, an application for accessing NEF 262, an application for interacting with a policy framework for policy control, and/or other types of applications. AF 254 may be accessible via an Naf interface 255, also referred to as an NG5 interface. In some implementations, AF 254 may correspond to, or interface with, application server 160.

PCF 256 may support policies to control network behavior, provide policy rules to control plane functions (e.g., to SMF 240), access subscription information relevant to policy decisions, perform policy decisions, and/or perform other types of processes associated with policy enforcement. PCF 256 may be accessible via Npcf interface 257. CHF 258 may perform charging and/or billing functions for core network 140. CHF 258 may be accessible via Nchf interface 259.

NRF 260 may support a service discovery function and maintain profiles of available network function (NF) instances and their supported services. An NF profile may include an NF ID, an NF type, a PLMN ID associated with the NF, network slice IDs associated with the NF, capacity information for the NF, service authorization information for the NF, supported services associated with the NF, endpoint information for each supported service associated with the NF, and/or other types of NF information. NRF 258 may be accessible via an Nnrf interface 261.

NEF 262 may expose services, capabilities, and/or events to other NFs, including third party NFs, AFs, edge computing NFs, and/or other types of NFs. Furthermore, NEF 262 may secure provisioning of information from external applications to core network 140-H, translate information between core network 140-H and devices/networks external to core network 140-H, support a Packet Flow Description (PFD) function, and/or perform other types of network exposure functions.

NSSF 264 may select a set of network slice instances to serve a particular UE device 110, determine network slice selection assistance information (NSSAI), determine a particular AMF 220 to serve a particular UE device 110, and/or perform other types of processing associated with network slice selection or management. NSSF 264 may provide a list of allowed slices for a particular UE device 110 to UDM 252 to store in a subscription profile associated with the particular UE device 110. NSSF 264 may be accessible via Nnssf interface 265.

NWDAF 266 may collect analytics information associated with RAN 120-H and/or core network 140-H. For example, NWDAF 268 may obtain telemetry information relating to home RAN 120-H from gNodeB 210 and provide collected telemetry information relating to UE device 110 to NEF 260. In some implementations, visited core network 140-V may be configured to provide, while UE device 11o is connected to visited core network 140-V, Key Performance Indicator (KPI) data relating to UE device 110 to NWDAF 266 via visited SEPP 270-V and home SEPP 270-H.

SEPP 270 (e.g., SEPP 270-H in home core network 140-H, etc.) may implement application layer security for all layer information exchanged between two NFs across two different PLMNs. SEPP 270 may act as the only point of contact into and out of home core network 140-H for application-level traffic with respect to other MNOs and/or PLMNs. For example, home SEPP 270-H may act as the point of contact between home core network 140-H and visited core network 140-V via visited SEPP 270-V. Home SEPP 270-H and visited SEPP 270-V may communicate via an N32 interface 272. N32 interface 272 may include an N32-c control plane interface between SEPPs 270 for performing an initial handshake and negotiating the parameters to be applied for the N32 message forwarding. Furthermore, N32 interface 272 may include an N32-f forwarding interface between SEPPs 270 that is used for forwarding communication between an NF consumer (e.g., the NF originating a request, etc.) and an NF producer (e.g., the NF responding to the request, etc.) after applying application-level security protection (e.g., authentication of the request, etc.).

Home SEPP 270-H may receive a request from visited SEPP 270-V on behalf of UE device 110, send an authentication request for UE device 110 to UDM 252, receive an authentication response for UE device 110 from UDM 252, perform an authentication for UE device 110 based on the received authentication response, and either approve or deny the received request based on the results of the authentication. If the request is approved, home SEPP 270-H may forward the request to the appropriate NF in home core network 140-H, such as, for example, to AMF 220, SMF 240, UDM 252, AF 254, PCF 256, CHF 258, NEF 262, and/or NWDAF 266. In other implementations, home SEPP 270-H may be configured to communicate directly with UDR 250 to authenticate a request from a VPLMN for UE device 110. In some implementations, home SEPP 270-H may perform the authentication for UE device 110 by performing a previous location check and/or a time location check for UE device 110 based on information received from UDM 252 (or directly from UDR 250). In other implementations, a previous location check and/or a time location check for UE device 110 may be performed by UDM 252 and the results of the previous location check and/or time location check may be provided by UDM 252 to home SEPP 270-H.

Although FIG. 2 shows exemplary components of home core network 140 (or visited core network 145), in other implementations, home core network 140 (or visited core network 145) may include fewer components, different components, differently arranged components, or additional components than depicted in FIG. 2. Additionally, or alternatively, one or more components of home core network 140-H may perform functions described as being performed by one or more other components of home core network 140-H. Furthermore, while particular interfaces have been described with respect to particular function nodes in FIG. 2, additionally, or alternatively, home core network 140-H may include a reference point architecture that includes point-to-point interfaces between particular function nodes.

FIG. 3 is a diagram illustrating example components of a device 300 according to an implementation described herein. Each of the components of FIGS. 1 and/or 2 may include, or be implemented on, one or more devices 300. As shown in FIG. 3, device 300 may include a bus 310, a processor 320, a memory 330, an input device 340, an output device 350, and a communication interface 360.

Bus 310 may include a path that permits communication among the components of device 300. Processor 320 may include any type of single-core processor, multi-core processor, microprocessor, latch-based processor, central processing unit (CPU), graphics processing unit (GPU), tensor processing unit (TPU), hardware accelerator, and/or processing logic (or families of processors, microprocessors, and/or processing logics) that interprets and executes instructions. In other embodiments, processor 320 may include an application-specific integrated circuit (ASIC), a field-programmable gate array (FPGA), and/or another type of integrated circuit or processing logic.

Memory 330 may include any type of dynamic storage device that may store information and/or instructions, for execution by processor 320, and/or any type of non-volatile storage device that may store information for use by processor 320. For example, memory 330 may include random access memory (RAM) or another type of dynamic storage device, read-only memory (ROM) device or another type of static storage device, content addressable memory (CAM), a magnetic and/or optical recording memory device and its corresponding drive (e.g., a hard disk drive, an optical drive, etc.), and/or a removable form of memory, such as flash memory.

Input device 340 may allow an operator to input information into device 300. Input device 340 may include, for example, a keyboard, a mouse, a pen, a microphone, a remote control, an audio capture device, an image and/or video capture device, a touch-screen display, and/or another type of input device. In some implementations, device 300 may be managed remotely and may not include input device 340. In other words, device 300 may be “headless” and may not include a keyboard, for example.

Output device 350 may output information to an operator of device 300. Output device 350 may include a display, a printer, a speaker, and/or another type of output device. For example, device 300 may include a display, which may include a liquid-crystal display (LCD) for displaying content to the user. In some implementations, device 300 may be managed remotely and may not include output device 350. In other words, device 300 may be “headless” and may not include a display, for example.

Communication interface 360 may include a transceiver that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 360 may include a transmitter that converts baseband signals to radio frequency (RF) signals and/or a receiver that converts RF signals to baseband signals. Communication interface 360 may be coupled to an antenna for transmitting and receiving RF signals.

Communication interface 360 may include a logical component that includes input and/or output ports, input and/or output systems, and/or other input and output components that facilitate the transmission of data to other devices. For example, communication interface 360 may include a network interface card (e.g., Ethernet card) for wired communications and/or a wireless network interface (e.g., a WI-FI) card for wireless communications. Communication interface 360 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 300 may perform certain operations relating to preventing security attacks in 5G roaming scenarios by performing authentication check on requests received from a VPLMN. Device 300 may perform these operations in response to processor 320 executing software instructions contained in a computer-readable medium, such as memory 330. A computer-readable medium may be defined as a non-transitory memory device. A memory device may be implemented within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, additional components, or differently arranged components than depicted in FIG. 3. Additionally, or alternatively, one or more components of device 300 may perform one or more tasks described as being performed by one or more other components of device 300.

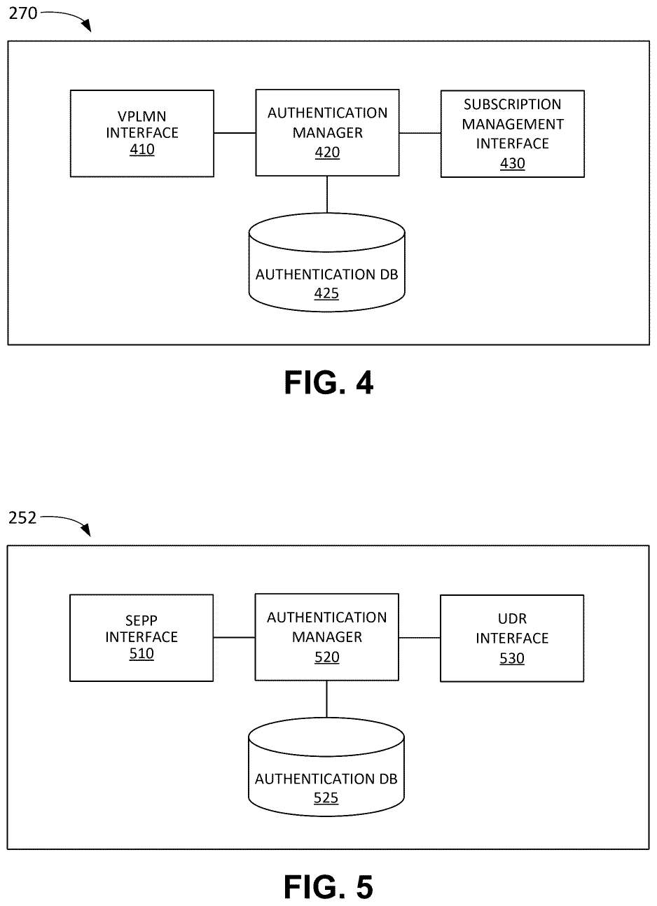

FIG. 4 is a diagram illustrating exemplary components of SEPP 270. The components of SEPP 270 may be implemented, for example, via processor 320 executing instructions from memory 330. Alternatively, some or all of the components of SEPP 270 may be implemented via hard-wired circuitry. As shown in FIG. 4, SEPP 270 may include a VPLMN interface 410, an authentication manager 420, an authentication database (DB) 425, and a subscription management interface 430.

VPLMN interface 410 may be configured to communicate with a VPLMN, such as visited core network 140-V. For example, VPLMN interface 410 may include an N32 interface 272. VPLMN interface 410 may receive a request from visited SEPP 270-V for UE device 110. The request may include, for example, a request to establish a PDU session for UE device 110, a request to establish a Quality of Service (QoS) data flow in an established PDU session associated with UE device 110, a Policy Association Request to obtain policies for a PDU session associated with UE device 110, a Registration Request to register UE device 110 with home core network 140-H, a request to report telemetry and/or KPI information for a PDU session and/or QoS data flow, associated with UE device 110, to NWDAF 266, and/or another type of request associated with UE device 110. VPLMN interface 410 may forward the received request to authentication manager 420 for authentication.

Authentication manager 420 may authenticate requests associated with UE device 110 received from a VPLMN. In some implementations, authentication manager 420 may perform an authentication process that includes a previous location check and/or a time location check for UE device 110. For example, authentication manager 420 may send an authentication request for UE device 110 to UDM 252, or directly to UDR 250. The authentication request may include information identifying UE device 110, such as, for example, a Mobile Directory Number (MDN), a Subscriber Permanent Identifier (SUPI), an International Mobile Subscriber Identity (IMSI), a Mobile Station International Subscriber Directory Number (MSISDN), and/or another type of ID associated with UE device 110. The authentication request may further include a VPLMN ID associated with the request received from visited SEPP 270-V. UDM 252, or UDR 250, may respond with an authentication response that includes a most recently determined PLMN ID for UE device 110 and a timestamp for the PLMN ID determined for UE device 110.

Authentication manager 420 may then perform an authentication of the request received from visited SEPP 270-V based on the authentication response received from UDM 252 or UDR 250 and based on information stored in authentication DB 425. Authentication DB 425 may store authentication criteria for authenticating requests received from VPLMNs. For example, authentication DB 425 may store a threshold for a location change. If the previous location check indicates that UE device 110 has changed VPLMNs, authentication manager 420 may perform a time check to determine the time difference between the timestamp associated with the previous VPLMN ID for UE device 110 with the timestamp associated with the current request received from visited SEPP 270-V. If the time difference between the timestamps is less than a threshold, indicating a rapid change of VPLMNs, authentication manager 420 may determine that the authentication has failed. In some implementations, a single VPLMN change with a timestamp difference less than a threshold may indicate authentication failure. In other implementations, multiple fast VPLMN changes may indicate authentication failure. Furthermore, different VPLMNs may be associated with different thresholds. For example, VPLMNs associated with countries designated as untrusted countries may be associated with a stricter threshold (e.g., a higher time difference threshold, etc.). Furthermore, a VPLMN change between non-bordering countries, or multiple VPLMN changes between non-bordering countries, may be associated with a stricter threshold.

In other implementations, authentication manager 420 may request that UDM 252 perform the authentication process and UDM 252 may perform the previous location check and/or time location check for UE device 110. Thus, authentication manager 420 may send an authentication request to UDM 252, UDM 252 may perform the previous location check and/or time location check for UE device 110, and authentication manager 420 may receive the results of the previous location check and/or time location check for UE device 110 from UDM 252. Thus, UDM 252 may indicate authentication success or failure in the response to authentication manager 420.

If authentication succeeds, authentication manager 420 may approve the request received from visited SEPP 270-V and forward the request to the target NF. For example, authentication manager 420 may forward the request to AMF 220, SMF 240, UDM 252, AF 254, PCF 256, CHF 258, NEF 262, NWDAF 266, and/or another NF in home core network 140-H. If authentication fails, authentication manager 420 may deny the request and send a “403 Forbidden” HTTP message back to visited SEPP 270-V. Additionally, authentication manager 420 may send an alert to an administrator device associated with home core network 140-H, indicating that an authentication for a request from a VPLMN has failed.

Subscription management interface 430 may be configured to communicate with UDM 252 and/or UDR 250. For example, in some implementations, subscription management interface 430 may be configured to communicate directly with UDR 250 to obtain location and/or timestamp information associated with UE device 110. In other implementations, subscription management interface 430 may be configured to communicate with UDM 252 to obtain location and/or timestamp information for UE device 110, and/or to request UDM 252 to perform a previous location check and/or a time location check for UE device 110.

Although FIG. 4 shows exemplary components of SEPP 270, in other implementations, SEPP 270 may include fewer components, different components, additional components, or differently arranged components than depicted in FIG. 4. Additionally, or alternatively, one or more components of SEPP 270 may perform one or more tasks described as being performed by one or more other components of SEPP 270.

FIG. 5 is a diagram illustrating exemplary components of UDM 252. The components of UDM 252 may be implemented, for example, via processor 320 executing instructions from memory 330. Alternatively, some or all of the components of UDM 252 may be implemented via hard-wired circuitry. As shown in FIG. 5, UDM 252 may include a SEPP interface 510, an authentication manager 520, an authentication DB 525, and a UDR interface 530.

SEPP interface 510 may be configured to communicate with SEPP 270. For example, SEPP interface 510 may be configured to receive a request from SEPP 270 to authenticate a request from a VPLMN and/or to perform a previous location check and/or time location check for UE device 110 associated with the request.

Authentication manager 520 may authenticate requests associated with UE device 110 received from a VPLMN. In some implementations, authentication manager 520 may perform an authentication process that includes a previous location check and/or a time location check for UE device 110. For example, authentication manager 520 may send an authentication request for UE device 110 to UDR 250. The authentication request may include information identifying UE device 110 and a VPLMN ID associated with the request received from visited SEPP 270-V. UDR interface 530 may implement an interface for communicating with UDR 250. UDR 250 may respond with an authentication response that includes a most recently determined PLMN ID for UE device 110 and a timestamp for the PLMN ID determined for UE device 110.

In some implementations, authentication manager 520 may forward the received authentication response to home SEPP 270-H. In other implementation, authentication manager 520 may perform an authentication of the request received from visited SEPP 270-V based on the authentication response received from UDR 250 and based on information stored in authentication DB 525. Authentication DB 525 may store authentication criteria for authenticating requests received from VPLMNs, such as, for example, the authentication criteria described above with reference to authentication DB 425.

Thus, authentication manager 520 may perform the previous location check and/or time location check for UE device 110. Authentication manager 520 may then send the result of the previous location check and/or time location check for UE device 110 to home SEPP 270-H. In some implementations, if the previous location check and/or time location check for UE device 110 fails, authentication manager 520 may send an alert to an administrator device associated with home core network 140-H, indicating that an authentication for a request from a VPLMN has failed.

Although FIG. 5 shows exemplary components of UDM 252, in other implementations, UDM 252 may include fewer components, different components, additional components, or differently arranged components than depicted in FIG. 5. Additionally, or alternatively, one or more components of UDM 252 may perform one or more tasks described as being performed by one or more other components of UDM 252.

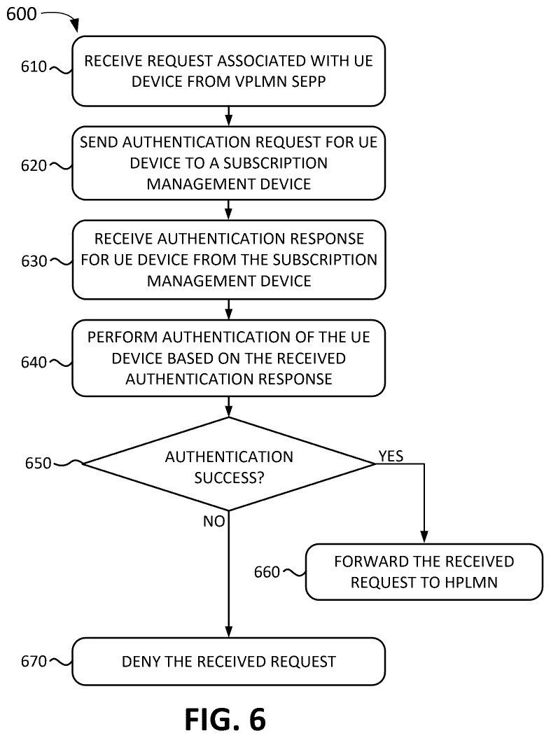

FIG. 6 illustrates a flowchart of a process 600 for authenticating a request from a VPLMN according to an implementation described herein. In some implementations, process 600 of FIG. 6 may be performed by SEPP 270. In other implementations, some or all of process 600 may be performed by another device or a group of devices separate from SEPP 270.

As shown in FIG. 6, process 600 may include receiving a request associated with a UE device from a VPLMN SEPP (block 610). For example, SEPP 270-H may receive a request from visited SEPP 270-V for UE device 110. The request may include, for example, a request to establish a PDU session for UE device 110, a request to establish a QoS data flow in an established PDU session associated with UE device 110, a Policy Association Request to obtain policies for a PDU session associated with UE device 110, a Registration Request to register UE device 110 with home core network 140-H, a request to report telemetry and/or KPI information for a PDU session and/or QoS data flow, associated with UE device 110, to NWDAF 266, and/or another type of request associated with UE device 110.

Process 600 may further include sending an authentication request for the UE device to a subscription management device (block 620), receiving an authentication response for the UE device from the subscription management device (block 630), and performing an authentication of the UE device based on the received authentication response (block 640). In some implementations, SEPP 270-H may perform an authentication process that includes a previous location check and/or a time location check for UE device 110. SEPP 270-H may send an authentication request for UE device 110 to UDM 252, or directly to UDR 250. The authentication request may include information identifying UE device 110 and a VPLMN ID associated with the request received from visited SEPP 270-V. UDM 252, or UDR 250, may respond with an authentication response that includes a most recently determined PLMN ID for UE device 110 and a timestamp for the PLMN ID determined for UE device 110. SEPP 270 may then perform an authentication of the request received from visited SEPP 270-V based on the authentication response received from UDM 252 or UDR 250. For example, SEPP 270-H may perform a time check to determine the time difference between the timestamp associated with the previous VPLMN ID for UE device 110 with the timestamp associated with the current request received from visited SEPP 270-V.

In other implementations, SEPP 270-H may request that UDM 252 perform the authentication process and UDM 252 may perform the previous location check and/or time location check for UE device 110. Thus, SEPP 270-H may send an authentication request to UDM 252, UDM 252 may perform the previous location check and/or time location check for UE device 110, and SEPP 270-H may receive the results of the previous location check and/or time location check for UE device 110 from UDM 252.

A determination may be made as to whether there was authentication success (block 650). For example, if the timestamp is less than a threshold, indicating a rapid change of VPLMNs, SEPP 270-H may determine that the authentication has failed. Authentication failure may be indicated based on a single VPLMN change with a timestamp difference less than a threshold may indicate authentication failure or based on multiple VPLMN changes faster than that specified by one or more thresholds.

If it is determined that there was authentication success (block 650—YES), the received request may be forwarded to the HPLMN (block 660). For example, if authentication succeeds, SEPP 270-H may approve the request received from visited SEPP 270-V and forward the request to the target NF. For example, SEPP 270-H may forward the request to AMF 220, SMF 240, UDM 252, AF 254, PCF 256, CHF 258, NEF 262, NWDAF 266, and/or another NF in home core network 140-H.

If it is determined that there was not authentication success (block 650—NO), the received request may be denied (block 670). For example, if authentication fails, SEPP 270-H may deny the request and send a “403 Forbidden” HTTP message back to visited SEPP 270-V. Additionally, SEPP 270-H may send an alert to an administrator device associated with home core network 140-H, indicating that an authentication for a request from a VPLMN has failed.

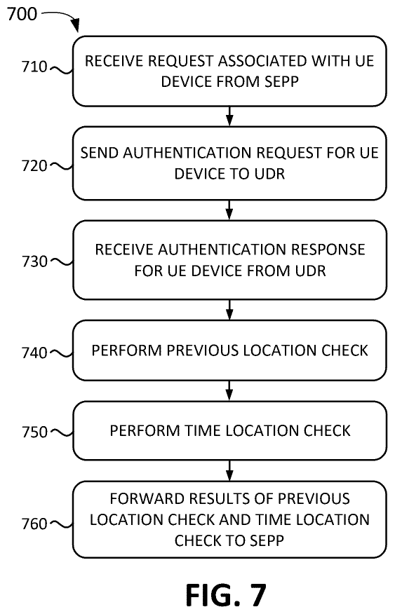

FIG. 7 illustrates a flowchart of a process 700 for authenticating a request from a VPLMN according to an implementation described herein. In some implementations, process 700 of FIG. 7 may be performed by UDM 252. In other implementations, some or all of process 700 may be performed by another device or a group of devices separate from UDM 252.

As shown in FIG. 7, process 700 may include receiving a request associated with a UE device from a SEPP (block 710). For example, UDM 252 may receive a request from SEPP 270-H to authenticate a request from a VPLMN and/or to perform a previous location check and/or time location check for UE device 110 associated with the request.

Process 700 may further include sending an authentication request for the UE device to a UDR (block 720) and receiving an authentication response for the UE device from the UDR (block 730). For example, UDM 252 may send an authentication request for UE device 110 to UDR 250. The authentication request may include information identifying UE device 110 and a VPLMN ID associated with the request received from visited SEPP 270-V. UDM 252 may receive, from UDR 250, an authentication response that includes a most recently determined PLMN ID for UE device 110 and a timestamp for the PLMN ID determined for UE device 110.

Process 700 may further include performing a previous location check for the UE device (block 740), performing a time location check for the UE device (block 750), and forwarding the results of the previous location check and the time location check for the UE device to the SEPP (block 760). For example, UDM 252 may perform the previous location check and/or time location check for UE device 110. UDM 252 may then send the result of the previous location check and/or time location check for UE device 110 to SEPP 270-H. In some implementations, if the previous location check and/or time location check for UE device 110 fails, authentication manager 520 may send an alert to an administrator device associated with home core network 140-H, indicating that an authentication for a request from a VPLMN has failed.

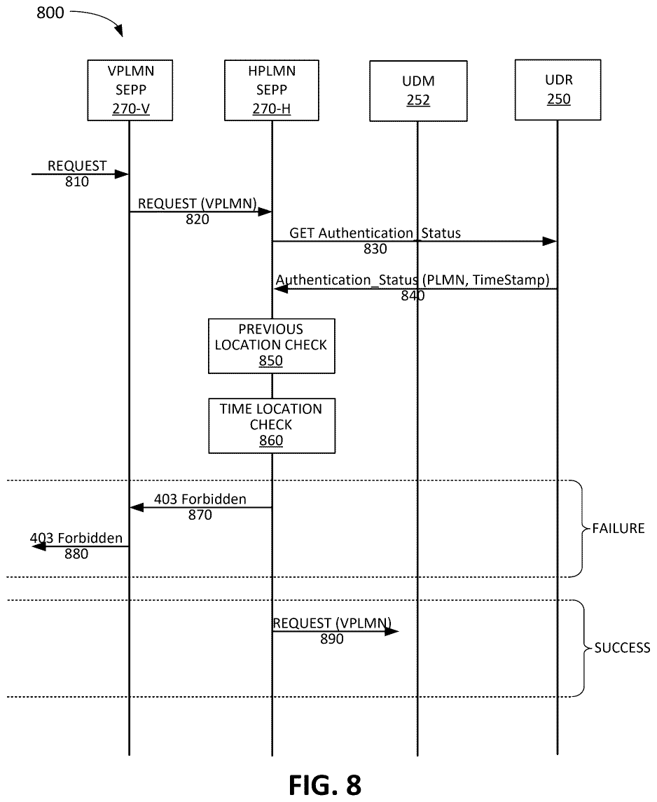

FIG. 8 illustrates an exemplary signal flow 800 according to an implementation described herein. In signal flow 800, home SEPP 270-H communicates directly with UDR 250. As shown in FIG. 8, signal flow 800 includes VPLMN (visited) SEPP 270-V receiving a request from visited core network 140-V (signal 810) and forwarding the request to HPLMN (home) SEPP 270-H (signal 820). The request may include, for example, a request to establish a PDU session for UE device 110, a request to establish a QoS data flow in an established PDU session associated with UE device 110, a Policy Association Request to obtain policies for a PDU session associated with UE device 110, a Registration Request to register UE device 110 with home core network 140-H, a request to report telemetry and/or KPI information for a PDU session and/or QoS data flow, associated with UE device 110, to NWDAF 266, and/or another type of request associated with UE device 110.

HPLMN SEPP 270-H may, in response, send an HTTP GET Authentication_Status message directly to UDR 250 to request a most recently reported PLMN ID for UE device 110 and a timestamp associated with the reported PLMN ID (signal 830). The HTTP GET Authentication_Status message may include information identifying UE device 110. UDR 250 may respond with an Authentication_Status message that includes the most recently reported PLMN ID for UE device 110 and a timestamp associated with the most recently reported PLMN ID (signal 840).

HPLMN SEPP 270-H may then perform a previous location check (block 850) and a time location check (block 860). The previous location check may determine whether the VPLMN ID associated with the request received from VPLMN SEPP 270-V is the same as the most recently reported PLMN ID for UE device 110 received from UDR 250. If the PLMN IDs are different, the time location check may determine the difference in time between the timestamp received from UDR 250 and the timestamp associated with the request received from VPLMN SEPP 270-V. If the timestamp difference is less than a threshold, HPLMN SEPP 270-H may determine that authentication failed, and may send an HTTP 403 Forbidden message to VPLMN SEPP 270-V (signal 870) and VPLMN SEPP 270-V may forward the HTTP 403 Forbidden message to the NF in visited core network 140-V that originated the request (signal 880). If the timestamp difference is not less than a threshold, HPLMN SEPP 270-H may determine that authentication succeeded, and may forward the request to the destination NF in home core network 140-H (signal 890).

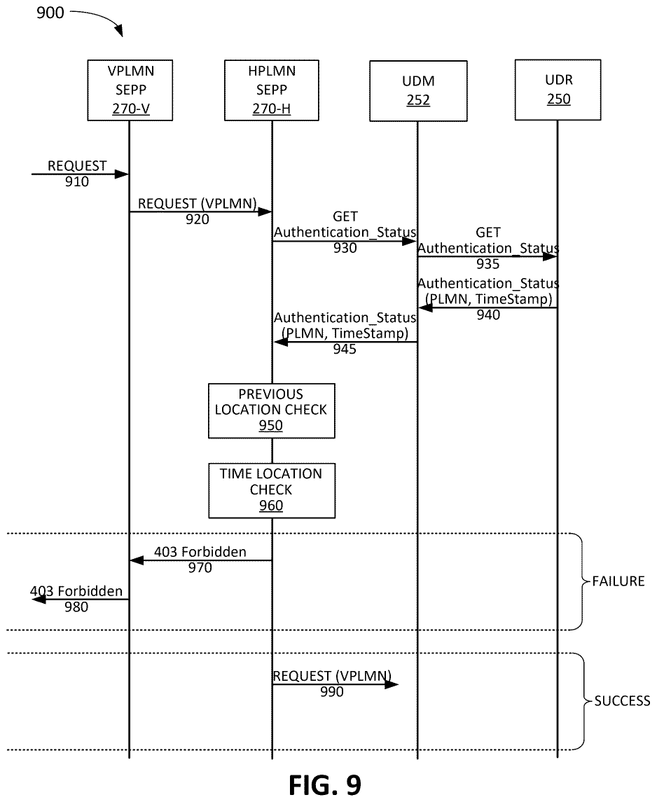

FIG. 9 illustrates a second exemplary signal flow 900 according to an implementation described herein. In signal flow 900, home SEPP 270-H communicates with UDM 252 to obtain information from UDR 250. As shown in FIG. 9, signal flow 900 includes VPLMN (visited) SEPP 270-V receiving a request from visited core network 140-V (signal 910) and forwarding the request to HPLMN (home) SEPP 270-H (signal 920). The request may include, for example, a request to establish a PDU session for UE device 110, a request to establish a QoS data flow in an established PDU session associated with UE device 110, a Policy Association Request to obtain policies for a PDU session associated with UE device 110, a Registration Request to register UE device 110 with home core network 140-H, a request to report telemetry and/or KPI information for a PDU session and/or QoS data flow, associated with UE device 110, to NWDAF 266, and/or another type of request associated with UE device 110.

HPLMN SEPP 270-H may, in response, send an HTTP GET Authentication_Status message to UDM 252 to request a most recently reported PLMN ID for UE device 110 and a timestamp associated with the reported PLMN ID (signal 930). The HTTP GET Authentication_Status message may include information identifying UE device 110. UDM 252 may forward the HTTP GET Authentication_Status message to UDR 250 (signal 935). UDR 250 may respond with an Authentication_Status message that includes the most recently reported PLMN ID for UE device 110 and a timestamp associated with the most recently reported PLMN ID (signal 940). UDM 252 may forward the Authentication_Status message to HPLMN SEPP 270-H (signal 945).

HPLMN SEPP 270-H may then perform a previous location check (block 950) and a time location check (block 960). The previous location check may determine whether the VPLMN ID associated with the request received from VPLMN SEPP 270-V is the same as the most recently reported PLMN ID for UE device 110 received from UDR 250. If the PLMN IDs are different, the time location check may determine the difference in time between the timestamp received from UDR 250 and the timestamp associated with the request received from VPLMN SEPP 270-V. If the timestamp difference is less than a threshold, HPLMN SEPP 270-H may determine that authentication failed, and may send an HTTP 403 Forbidden message to VPLMN SEPP 270-V (signal 970) and VPLMN SEPP 270-V may forward the HTTP 403 Forbidden message to the NF in visited core network 140-V that originated the request (signal 880). If the timestamp difference is not less than a threshold, HPLMN SEPP 270-H may determine that authentication succeeded, and may forward the request to the destination NF in home core network 140-H (signal 990).

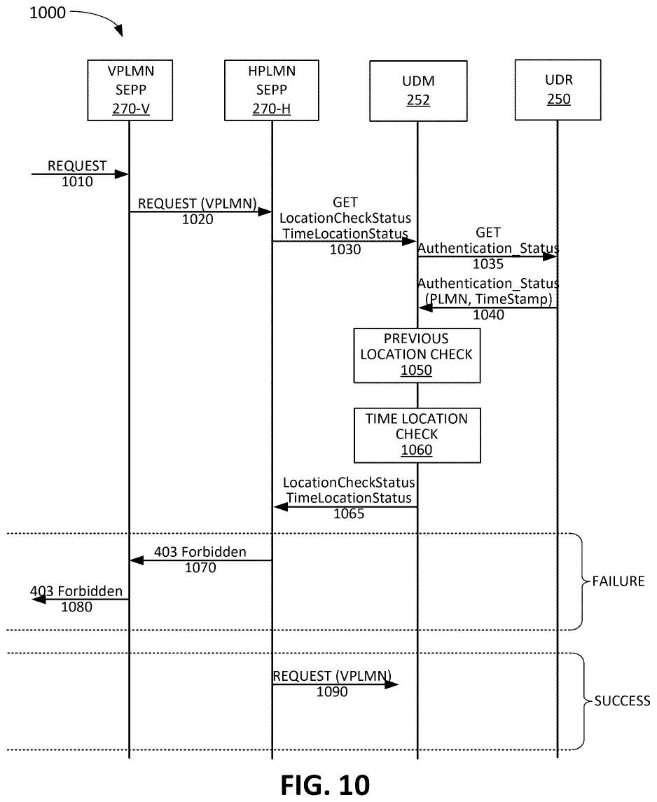

FIG. 10 illustrates a third exemplary signal flow 1000 according to an implementation described herein. In signal flow 1000, UDM 252 performs the authentication checks on behalf of HPLMN SEPP 270-H. As shown in FIG. 10, signal flow 1000 includes VPLMN (visited) SEPP 270-V receiving a request from visited core network 140-V (signal 1010) and forwarding the request to HPLMN (home) SEPP 270-H (signal 1020). The request may include, for example, a request to establish a PDU session for UE device 110, a request to establish a QoS data flow in an established PDU session associated with UE device 110, a Policy Association Request to obtain policies for a PDU session associated with UE device 110, a Registration Request to register UE device 110 with home core network 140-H, a request to report telemetry and/or KPI information for a PDU session and/or QoS data flow, associated with UE device 110, to NWDAF 266, and/or another type of request associated with UE device 110.

HPLMN SEPP 270-H may, in response, send an HTTP GET LocationStatusCheck and TimeLocationStatus message to UDM 252 to request UDM 252 to perform a previous location check and a time location check for UE device 110 and to provide the results back to HPLMN SEPP 270-H (signal 1030). UDM 252 may send a HTTP GET Authentication_Status message to UDR 250 (signal 1035). The HTTP GET Authentication_Status message may include information identifying UE device 110. UDR 250 may respond with an Authentication_Status message that includes the most recently reported PLMN ID for UE device 110 and a timestamp associated with the most recently reported PLMN ID (signal 1040).

UDM 252 may then perform a previous location check (block 1050) and a time location check (block 1060). The previous location check may determine whether the VPLMN ID associated with the request received from VPLMN SEPP 270-V is the same as the most recently reported PLMN ID for UE device 110 received from UDR 250. If the PLMN IDs are different, the time location check may determine the difference in time between the timestamp received from UDR 250 and the timestamp associated with the request received from VPLMN SEPP 270-V. UDM 252 may provide a LocationStatusCheck and TimeLocationStatus message to HPLMN SEPP 270-H, indicating whether there is a difference in the PLMN ID for UE device 110 and a time difference between the previously reported PLMN ID and the currently received request from VPLMN SEPP 270-V (signal 1065).

If the timestamp difference is less than a threshold, HPLMN SEPP 270-H may determine that authentication failed, and may send an HTTP 403 Forbidden message to VPLMN SEPP 270-V (signal 1070) and VPLMN SEPP 270-V may forward the HTTP 403 Forbidden message to the NF in visited core network 140-V that originated the request (signal 1080). If the timestamp difference is not less than a threshold, HPLMN SEPP 270-H may determine that authentication succeeded, and may forward the request to the destination NF in home core network 140-H (signal 1090).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 6 and 7, and a series of signals have been described with respect to FIGS. 8, 9, and 10, the order of the blocks and/or signals may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
receiving, by a device, a request from a Security Edge Protection Proxy (SEPP) in a Visited Public Land Mobile Network (VPLMN), wherein the request is associated with a User Equipment (UE) device;
sending, by the device, an authentication request for the UE device to a subscription management device;
receiving, by the device, an authentication response for the UE device from the subscription management device;
performing, by the device, an authentication of the UE device based on the received authentication response; and
responding, by the device, to the request based on the performed authentication of the UE device.

2. The method of claim 1, wherein the device includes a SEPP in a Home Public Land Mobile Network (HPLMN) associated with the UE device.

3. The method of claim 1, wherein the subscription management device includes a Unified Data Repository (UDR).

4. The method of claim 1, wherein the subscription management device includes a Unified Data Management (UDM) function.

5. The method of claim 4, wherein the authentication request for the UE device includes a request to perform a previous location check for the UE device.

6. The method of claim 4, wherein the authentication request for the UE device includes a request to perform a time location check for the UE device.

7. The method of claim 1, wherein the authentication response for the UE device includes information identifying a most recently reported Public Land Mobile Network (PLMN) to which the UE device was connected and a timestamp associated with a report of the most recently reported PLMN to which the UE device was connected.

8. The method of claim 1, wherein performing the authentication of the UE device based on the received authentication response includes:
performing a previous location check for the UE device based on the received authentication response; and
performing a time location check for the UE device based on the received authentication response.

9. The method of claim 8, wherein responding to the request based on the performed authentication of the UE device includes:
approving the request, when the previous location check satisfies a previous location requirement and the time location check satisfies a time location requirement.

10. The method of claim 8, wherein responding to the request based on the performed authentication of the UE device includes:
denying the request, when the previous location check does not satisfy a previous location requirement or when the time location check does not satisfy a time location requirement.

11. The method of claim 1, wherein the request includes at least one of:
a Protocol Data Unit (PDU) session establishment request,
a Policy Association Request;
a Registration Request; or
a request to report telemetry information.

12. A device comprising:
a processor configured to:
receive a request from a Security Edge Protection Proxy (SEPP) in a Visited Public Land Mobile Network (VPLMN), wherein the request is associated with a User Equipment (UE) device;
send an authentication request for the UE device to a subscription management device;
receive an authentication response for the UE device from the subscription management device;
perform an authentication of the UE device based on the received authentication response; and
respond to the request based on the performed authentication of the UE device.

13. The device of claim 12, wherein the device includes a SEPP in a Home Public Land Mobile Network (HPLMN) associated with the UE device.

14. The device of claim 12, wherein the subscription management device includes a Unified Data Repository (UDR).

15. The device of claim 12, wherein the subscription management device includes a Unified Data Management (UDM) function.

16. The device of claim 12, wherein the authentication request for the UE device includes a request to perform a previous location check for the UE device and a time location check for the UE device.

17. The device of claim 12, wherein, when performing the authentication of the UE device based on the received authentication response, the processor is configured to:
perform a previous location check for the UE device based on the received authentication response; and
perform a time location check for the UE device based on the received authentication response.

18. The device of claim 17, wherein, when responding to the request based on the performed authentication of the UE device, the processor is configured to:
approve the request, when the previous location check satisfies a previous location requirement and the time location check satisfies a time location requirement.

19. The device of claim 17, wherein, when responding to the request based on the performed authentication of the UE device, the processor is configured to:
deny the request, when the previous location check does not satisfy a previous location requirement or when the time location check does not satisfy a time location requirement.

20. A non-transitory computer-readable memory device storing instructions executable by a processor, the non-transitory computer-readable memory device comprising:
one or more instructions to receive a request from a Security Edge Protection Proxy (SEPP) in a Visited Public Land Mobile Network (VPLMN), wherein the request is associated with a User Equipment (UE) device;
one or more instructions to send an authentication request for the UE device to a subscription management device;
one or more instructions to receive an authentication response for the UE device from the subscription management device;
one or more instructions to perform an authentication of the UE device based on the received authentication response; and
one or more instructions to respond to the request based on the performed authentication of the UE device.
